(19) United States
(12) Patent Application Publication
(10) Pub. No.: US 2026/0260933 A1
(43) Pub. Date: Sep. 3, 2026

(54) POLYMER COMPOSITION FOR ELECTROLYTE AND/OR POSITIVE ELECTRODE OF A RECHARGEABLE BATTERY

(71) Applicant: BLUE SOLUTIONS, Ergue Gaberic (FR)

(72) Inventors: Léo BARROME, Ergue Gaberic (FR); Camille TANDE, Ergue Gaberic (FR); Jean-Christophe LECERF, Ergue Gaberic (FR); Stéphane LE ROUX, Ergue Gaberic (FR); Marc DESCHAMPS, Ergue Gaberic (FR); Margaud LECUYER, Ergue Gaberic (FR)

(73) Assignee: BLUE SOLUTIONS, Ergue Gaberic (FR)

(21) Appl. No.: 18/993,201

(22) PCT Filed: Jul. 10, 2023
(86) PCT No.: PCT/EP2023/069028

§ 371 Date: Jan. 10, 2025

(30) Foreign Application Priority Data
Jul. 11, 2022 (FR) FR2207083

(51) Int. Cl. H01M 10/0565; H01M 50/414; H01M 50/491

(52) U.S. Cl. CPC H01M 10/0565; H01M 50/414; H01M 50/491; H01M 2300/0082

(57) ABSTRACT

A polymer composition having improved ionic conduction properties, the use of such a polymer composition for the preparation of a polymer electrolyte and/or a positive electrode of a rechargeable battery, a polymer electrolyte for a rechargeable battery including such a polymer composition, a positive electrode for a rechargeable battery including such a polymer composition, and a lithium or sodium rechargeable battery including such a polymer electrolyte and/or such a positive electrode.

### FIELD

The present invention relates to the field of rechargeable batteries, more specifically to the field of lithium or sodium rechargeable batteries, in particular used for the production of electric vehicles and/or the storage of intermittent power such as wind and/or solar power.

The invention more particularly relates to a polymer composition having improved ionic conduction properties, the use of such a polymer composition for the preparation of a polymer electrolyte and/or a positive electrode of a rechargeable battery, a polymer electrolyte for a rechargeable battery comprising such a polymer composition, a positive electrode for a rechargeable battery comprising such a polymer composition, and a lithium or sodium rechargeable battery comprising such a polymer electrolyte and/or such a positive electrode.

### BACKGROUND

Lithium-metal-polymer batteries currently on the market (or LMP®) are “all-solid-state” batteries generally in the form of a thin film wound several times, or several stacked thin films. This wound or stacked thin film has a thickness of the order of one hundred micrometers. It generally comprises at least four functional films: a negative electrode (anode) ensuring the supply of lithium ions during discharging, a positive electrode (cathode) acting as a receptacle where the lithium ions are inserted; a solid polymer electrolyte conducting lithium ions and located between the positive electrode and the negative electrode; and a current collector connected to the positive electrode to ensure the electrical connection. The negative electrode generally consists of a sheet of lithium metal or of a lithium alloy; the solid polymer electrolyte is generally composed of a polymer based on poly(ethylene oxide) (PEO) and at least one lithium salt; the positive electrode comprises an active electrode material, usually based on metal oxide (such as for example V₂O₅, LiV₃O₈, LiCoO₂, LiNiO₂, LiMn₂O₄ or LiNi_{0.5}Mn_{0.5}O₂) or based on a phosphate such as LiMPO₄ where M represents a metal cation selected from the group Fe, Mn, Co, Ni and Ti, and a combination thereof, and optionally carbon; and the current collector is generally made of a metal sheet.

The solid polymer electrolyte provides a great advantage in terms of safety since it bypasses the use of solvents that are potentially dangerous in the event of overheating. Such batteries can thus work at high temperatures without risks of explosion. However, the solid polymer electrolytes that are generally used, such as high molecular mass PEO doped with lithium salt, have low ionic conductivity at room temperature, their operating temperature must therefore be kept relatively high (typically between 70 and 100° C.). But at these temperatures, PEO becomes a viscous liquid and loses its dimensional stability. In addition, attempts to improve the ionic conductivity of PEO by adding plasticizers have led to deterioration in mechanical properties.

The ionic conductivity of an electrolyte characterizes the ability of electrically charged ions to move through it. The higher it is, the greater the movement of ions within it. A polymer electrolyte can be considered interesting if it has an ionic conductivity of at least 10⁻⁵ S/cm. The transport number of an ion, denoted t, represents the fraction of the applied electric current that this ion will transport within the electrolyte. t is between 0 and 1. As lithium ions are the ones involved in the chemical reactions taking place at the electrodes of a lithium metal polymer battery, a transport number t as close as possible to 1 is desirable for an electrolyte. In solid polymer electrolytes such as PEO doped with lithium salt, the fraction of charge the carried by lithium ions is low (of the order of 0.2), due to the strong interaction between the lithium cation and PEO chains, which limits electrical performance. A low cationic transport number leads to the formation of a salt concentration gradient in the thickness of the electrolyte during battery operation. This behavior generates salt depletion at the electrode, leading to increased electrolyte resistance and reduced power performance, and favors the formation of lithium dendrites, resulting in lower faradaic efficiency and, ultimately, short circuits.

In order to obtain t values close to 1, polymers in which the anions form covalent bonds with the polymer chain, and in which the lithium counterions are the only mobile species, have been described.

In particular, Meziane et al. (Electrochimica Acta, 2011, 57, 14-19) describes the preparation of a polystyrene bearing sulfonyl(trifluoromethylsulfonyl)imide groups by radical polymerization from sodium 4-styrene-sulfonyl(trifluoromethylsulfonyl)imide monomers. This ionic polystyrene is then mixed with PEO to produce an electrolyte membrane containing no additional lithium ions. However, the results obtained show a relatively low ionic conductivity for temperatures below 60° C. (e.g. of the order of 3.1×10⁻⁶ S/cm).

Thus, the aim of the present invention is to overcome the drawbacks of the aforementioned prior art and to provide a polymer composition which exhibits improved ionic conduction properties and a high lithium ion transport number, while guaranteeing good mechanical strength, so that it can be used as the polymer electrolyte of a rechargeable battery, and in particular a lithium or sodium rechargeable battery.

### SUMMARY

The aim of the invention is achieved by the polymer composition described below.

Indeed, the inventors of the present application have surprisingly discovered that it is possible to add an ionically non-conductive fluoropolymer to a particular cationic unipolar conducting polymer associated with a plasticizer, in order to significantly improve the ionic conduction of a polymer composition.

### Polymer Composition

The first object of the present invention is thus a polymer composition, characterized in that it comprises at least one cationic unipolar conducting polymer, at least one plasticizer, and at least one ionically non-conductive fluoropolymer, said cationic unipolar conducting polymer being a homopolymer or copolymer comprising at least one organic polymer chain, organic anionic functions forming covalent bonds with the organic polymer chain, and metal cations associated (ionically) with the organic anionic functions.

The combination of a cationic unipolar-conducting polymer as defined above, a plasticizer and an ionically non-conductive fluoropolymer produces a polymer composition with improved ionic conduction properties.

### BRIEF DESCRIPTION OF THE DRAWINGS

The appended drawings illustrate the invention.

FIG. 1 shows the change in ionic conductivity in S.cm⁻¹ as a function of temperature (in Kelvin-1) for a conventional polymer electrolyte and polymer electrolytes of the invention.

FIG. 2 shows the change in ionic conductivity in S.cm⁻¹ as a function of temperature (in Kelvin-1) for a conventional polymer electrolyte and polymer electrolytes of the invention.

FIG. 3 shows the change in ionic conductivity in S.cm⁻¹ as a function of temperature (in Kelvin-1) for a conventional polymer electrolyte and polymer electrolytes of the invention.

FIG. 4 shows the change in ionic conductivity in S.cm⁻¹ as a function of temperature (in Kelvin-1) for conventional polymer electrolytes.

FIG. 5 shows the opposite of the imaginary part of the impedance −Z″ in ohms, as a function of the real part of the impedance Z′ in ohms for a conventional positive electrode and for a positive electrode of the invention.

FIG. 6 shows the capacity (in mAh/g) and efficiency (in %) as a function of the number of cycles of a battery conforming to the invention.

FIG. 7 shows the internal resistance Ri (in Ohm.cm²) of a battery according to the invention, as a function of the number of discharge and charge cycles.

FIG. 8 shows the capacity (in mAh/g) and efficiency (in %) as a function of the number of cycles of a battery conforming to the invention.

FIG. 9 shows the internal resistance Ri (in Ohm.cm²) of a battery according to the invention, as a function of the number of discharge and charge cycles.

FIG. 10 shows the change in ionic conductivity in S.cm⁻¹ as a function of temperature (in Kelvin-1) for a conventional polymer electrolyte and a polymer electrolyte of the invention.

### DETAILED DESCRIPTION

### Cationic Unipolar Conducting Polymer

In the invention, cationic unipolar-conducting polymer means a polymer (homopolymer or copolymer) comprising at least one organic polymer chain, organic anionic functions forming covalent bonds with the organic polymer chain, and metal cations associated with the organic anionic functions. These metal cations are mobile species responsible for the polymer's ionic conduction. In other words, the organic anionic functions are grafted onto the organic polymer chain, and/or are pendant organic anionic functions.

The term “organic polymer chain” means a polymer chain free of metal and metalloids. In other words, the organic polymer chain does not comprise a metal or metalloid such as silicon, or is different from a polysiloxane chain, or does not comprise an Si—O bond.

The term “organic anionic function” means an anionic function free of metal and metalloids. In other words, the organic anionic function does not comprise a metal or metalloid such as silicon, or does not comprise an Si—O bond.

The cationic unipolar conducting polymer of the invention is a polymer comprising organic anionic repeating units (organic polymer chain and organic anionic functions covalently bonded to said organic chain), said organic anionic repeating units being associated (ionically) with metal cations.

The cationic unipolar conducting polymer is preferably obtained by radical polymerization, in particular using at least one monomer comprising at least one organic anionic function covalently grafted onto said monomer and at least one metal cation associated with the organic anionic function.

The cationic unipolar conducting polymer can be:
a homopolymer preparable from a) a monomer comprising at least one organic anionic function covalently grafted onto said monomer and at least one metal cation associated with the organic anionic function; or
a copolymer preparable from a) a monomer comprising at least one organic anionic function covalently grafted onto said monomer and at least one metal cation associated with the organic anionic function, and b) at least one other monomer different from monomer a), selected from b1) monomers comprising at least one organic anionic function covalently grafted onto said monomer and at least one metal cation associated with the organic anionic function, and b2) organic monomers.

The term “organic monomer b2)” means a monomer that is free of metals and metalloids. In other words, the organic monomer does not comprise a metal or metalloid such as silicon and/or is not a compound comprising Si—O bonds.

The metal cation (of the monomer) or metal cations (of the polymer) associated with the organic anionic functions are preferably chosen from Li⁺ and Na⁺ cations, and particularly preferably are Li⁺ cations.

Monomer a) or b1), i.e. one comprising at least one organic anionic function covalently grafted onto said monomer and at least one metal cation associated with the organic anionic function, may be selected from aromatic and non-aromatic vinyl monomers, comprising at least one organic anionic function covalently grafted onto said organic monomer and at least one metal cation associated with the organic anionic function.

Examples of aromatic vinyl monomers include styrene and its derivatives.

Styrene derivatives are preferably derivatives in which the phenyl moiety of the styrene is substituted by one or more groups selected from methyl, ethyl and tert-butyl.

Examples of non-aromatic vinyl monomers include acrylate, methacrylate, acrylamide, methacrylamide, ethylene, propylene, dienes or maleimide.

Organic monomer b2) can be a vinylidene fluoride, phosphate, phosphonate, ether, carbonate, malonate, amide, acrylate, anhydride or ester.

In this embodiment, the copolymer comprises, in addition to organic anionic repeating units associated with metal cations, vinylidene fluoride, phosphate, phosphonate, ether, carbonate, malonate, amide, acrylate, anhydride or ester repeating units.

The organic anionic function (of monomers a) and b1)) or the organic anionic functions (of the polymer) can be chosen from sulfonate, borate and imidide functions.

The organic anionic functions are preferably imidides, particularly preferably bis sulfonyl imidides, more particularly preferably sulfonyl(trifluoromethane sulfonyl) imidides (TFSI) or sulfonyl(fluorosulfonyl) (FSI) imidides, and even more particularly preferably sulfonyl(trifluoromethane) imidides (TFSI).

According to a particularly preferred embodiment of the invention, the aromatic or non-aromatic vinyl monomer, comprising at least one organic anionic imidide function covalently grafted onto said monomer and Li⁺ as the metal cation associated with the organic anionic imidide function, is selected from the following monomers (I-a) to (I-i):

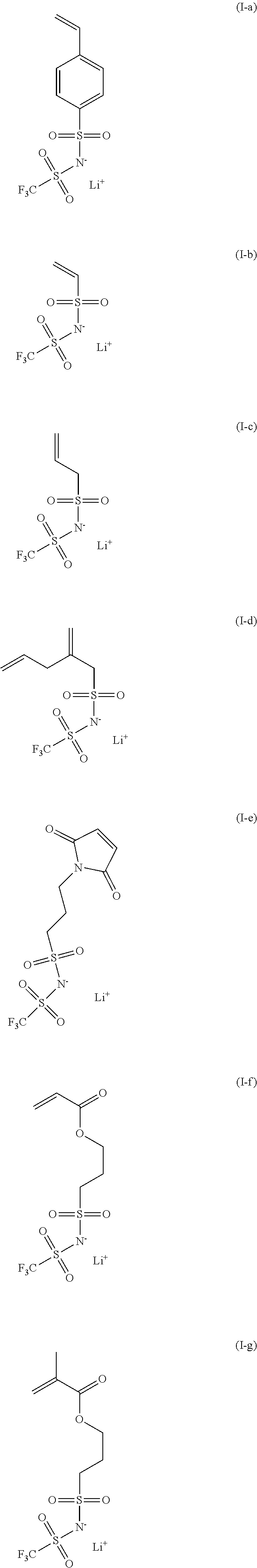

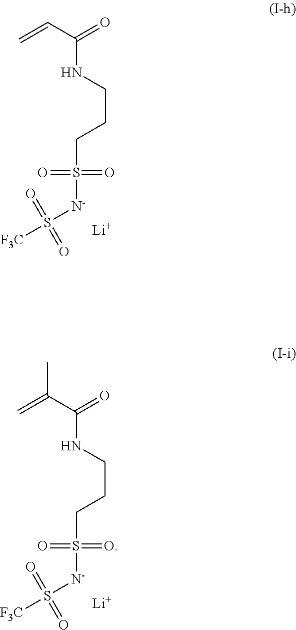 [SMILES: C=CC(=O)NCCCS(=O)(=O)[N-]S(=O)(=O)C(F)(F)F ; [Li+] ; C=C(C)C(=O)NCCCS(=O)(=O)[N-]S(=O)(=O)C(F)(F)F ; [Li+]]

The cationic unipolar conducting polymer is preferably a polystyrene-sulfonyl(trifluoromethylsulfonyl) lithium imide (PSTFSILi) or a polymethacrylate-sulfonyl(trifluoromethylsulfonyl) lithium imide (PMTFSILi).

The cationic unipolar conducting polymer preferably has a number-average molar mass (i.e. Mn) ranging from approx. 10,000 g/mol to 1,000,000 g/mol, and particularly preferably from approx. 50,000 g/mol to 700,000 g/mol.

In the invention, the number-average molecular weight is measured by methods well known to the person skilled in the art, and in particular by gel permeation chromatography (GPC).

The cationic unipolar conducting polymer preferably represents from 5% to 40% by mass approximately, even more particularly preferably from 5% to 30% by mass approximately, relative to the total mass of the polymer composition.

The cationic unipolar conducting polymer already comprises anionic functions (anionic groups derived from a lithium salt or a sodium salt directly grafted into the structure of the polymer material). The polymer composition therefore preferably comprises no additional or supplementary lithium or sodium salt(s), e.g. molecular lithium or sodium salts (i.e. lithium or sodium salts not grafted to a polymer material).

### Ionically Non-Conductive Fluoropolymer

In the invention, an ionically non-conductive polymer is a polymer that does not allow lithium or sodium ions to conduct. In other words, an ionically non-conductive polymer has an ionic conductivity of less than 10⁻⁷ S/cm, particularly at the working temperature.

The ionically non-conductive fluoropolymer preferably represents from 5% to 45% by mass approximately, even more particularly preferably from 5% to 40% by mass approximately, relative to the total mass of the polymer composition.

The ionically non-conductive polymer is fluorinated. In other words, it is a polymer whose repeating unit is a fluorocarbon, and therefore comprises a plurality of carbon-fluorine bonds.

The ionically non-conductive fluoropolymer of the polymer composition of the invention can be selected from vinyl fluoride (VF) homopolymers and copolymers, vinylidene fluoride (VdF) homopolymers and copolymers, ethylene tetrafluoride (TFE) homopolymers and copolymers, chlorotrifluoroethylene (CTFE) homopolymers and copolymers, hexafluoropropylene (HFP) homopolymers and copolymers, and a mixture thereof.

According to a particularly preferred embodiment of the invention, the ionically non-conductive fluoropolymer is chosen from vinylidene fluoride (VdF) homopolymers and copolymers such as PVdF or P(VdF-HFP).

According to a more particularly preferred embodiment, the ionically non-conductive fluoropolymer is PVdF.

The ratio by weight of non-conductive fluoropolymer to cationic unipolar conducting polymer in the polymer composition is preferably from about 20/80 to 90/10, and particularly preferably from about 40/60 to 80/20.

The ionically non-conductive fluoropolymer preferably has a number-average molar mass (i.e. Mn) ranging from around 50,000 g/mol to 1,300,000 g/mol.

### Plasticizer

The polymer composition comprises at least one plasticizer.

The plasticizer is a non-aqueous solvent. This makes it possible to form a gel-like polymer composition.

The non-aqueous solvent or plasticizer may be selected from:
linear and cyclic carbonates such as propylene carbonate (PC), ethylene carbonate (EC), dimethyl carbonate (DMC), diethyl carbonate (DEC), or methyl isopropyl carbonate (MiPC);
fluorinated carbonates such as fluoroethylene carbonate;
nitriles such as succinonitrile;
lactones such as γ-butyrolactone;
liquid linear and cyclic polyethers such as dimethyl ether, polyethylene glycol dimethyl ether (or PEGDME) such as tetraethylene glycol dimethyl ether (TEGDME), or dioxolane;
fluorinated polyethers;
sulfur solvents such as sulfolane or dimethyl sulfoxide;
phosphates such as triethylphosphate or fluorophosphates;
esters such as ethyl acetate or ethyl butyrate (EB); and
mixtures thereof.

Among such solvents or plasticizers, linear and cyclic carbonates are particularly preferred.

The solvent or plasticizer is preferably about 25% to 90% by weight, particularly preferably about 35% to 90% by weight, and even more preferably about 65% to 90% by weight, based on the total weight of the polymer composition.

### Additives in the Polymer Composition

The polymer composition of the invention may further comprise a reinforcing agent. This thus makes it possible to modulate the mechanical properties of the polymer composition.

Said reinforcing agent is preferably selected from cellulose nanofibrils, and ceramic nanoparticles such as titanium oxide, aluminum oxide, or silicon oxide nanoparticles.

According to a particularly preferred embodiment of the invention, the polymer composition comprises (or consists of):
about 40 to 90% by weight of plasticizer, and preferably about 65 to 90% by weight of plasticizer,
about 5 to 35% by weight of ionically non-conductive fluoropolymer, and
about 5 to 35% by weight of cationic unipolar conducting polymer.

Indeed, the blend of ionically non-conductive fluoropolymer and cationic unipolar conductive polymer is capable of absorbing a plasticizer, while retaining good mechanical strength and remaining solid or quasi-solid. Furthermore, the presence of the plasticizer results in a solid or quasi-solid polymer composition with improved ionic conductivity (e.g. conductivity of at least 1×10⁻⁵ S/cm at 25° C.).

The polymer composition of the invention is preferably prepared by mixing the various components, namely the cationic unipolar conducting polymer, the plasticizer and the ionically non-conductive fluoropolymer. In particular, the components (ionically non-conductive fluoropolymer, cationic unipolar conductive polymer, and plasticizer) are mixed in an organic solvent such as acetonitrile, advantageously under magnetic stirring. Mixing can be carried out under heat, in particular at a temperature of at least 50° C., preferably at least 80° C., and even more preferably at least 90° C. The resulting mixture can then be deposited on a substrate by coating, advantageously at room temperature (e.g. 18-25° C.). Drying can then be carried out, in particular to remove the organic solvent.

### Use of the Polymer Composition

The second object of the invention is the use of a polymer composition as defined in the first object of the invention, for the preparation of a polymer electrolyte and/or a positive electrode of a rechargeable battery, preferably a lithium or sodium rechargeable battery, particularly preferably a lithium metal or sodium metal battery, and more particularly preferably a lithium metal battery.

The use of a polymer composition in accordance with the present invention for the preparation of a polymer electrolyte of a rechargeable lithium battery leads to an energy storage device with excellent low-temperature performance (i.e. <60° C., and preferably ≤40° C.), in particular a lithium ion transport number of the order of 1, and an ionic conductivity greater than or equal to 10⁻⁵ S.cm⁻¹, preferably greater than or equal to 5×10⁻⁵ S.cm⁻¹, and particularly preferably greater than or equal to 10⁻⁴ S.cm⁻¹, at a temperature of up to 40° C. The high transport number limits the formation of concentration gradients in the polymer electrolyte while discharging (respectively charging), thereby increasing power performance (respectively charge speed). The use of this polymer composition also makes it possible to limit the dendritic growth of lithium, and thus to envisage fast, safe recharging. This is because the problem with lithium metal battery technology is the formation of heterogeneous lithium electro-deposits (including dendrites) during recharging, which reduces cyclability and can lead to short-circuiting. The polymer composition conforming to the present invention also exhibits good mechanical strength, high thermal stability (which ensures the safety of energy storage devices incorporating them), and improved potential stability (e.g. stability up to 4.5 V vs Li⁺/Li).

The use of a polymer composition conforming to the present invention for the preparation of a positive electrode of a rechargeable lithium metal or sodium metal battery makes it possible to improve ionic conductivity and thus to lower the battery's operating temperature and improve its power response. The polymer composition also improves adhesion of the positive electrode to the current collector.

### Polymer Electrolyte

The third object of the invention is a polymer electrolyte for a rechargeable battery, characterized in that it comprises a polymer composition in accordance with the first object of the invention, or a porous separator impregnated with a polymer composition in accordance with the first object of the invention.

The porous separator can be made of an electronically non-conductive porous material, preferably a porous polymer material based on at least one polyolefin (e.g. polyethylene or polypropylene) or fiber (e.g. glass or wood fibers).

The polymer electrolyte is preferably in the form of a film, particularly preferably in the form of a film with a thickness ranging from about 5 to 45 μm, and more preferably from about 10 to 25 μm.

When the polymer electrolyte comprises (or consists of) a porous separator impregnated with a polymer composition according to the first object, the porous separator is preferably coated with the polymer composition on a first side and on a second side facing the first side.

The polymer (solid or quasi-solid) electrolyte can be prepared by any technique well-known to a person skilled in the art such as, for example, by coating, extrusion or pressing (cold or hot).

The polymer electrolyte is preferably suitable for a rechargeable lithium or sodium battery, particularly preferably for a lithium metal or sodium metal battery, and even more preferably for a lithium metal battery.

### The Positive Electrode

The fourth object of the invention is a positive electrode for a rechargeable battery, comprising a positive electrode active material, a polymer composition, and optionally an agent generating electron conductivity, characterized in that the polymer composition is as defined in the first object of the invention.

The positive electrolyte is preferably suitable for a rechargeable lithium or sodium battery, particularly preferably for a lithium metal or sodium metal battery, and even more preferably for a lithium metal battery.

### Positive Electrode Active Material

The active material of the positive electrode is a reversible active material of the lithium or sodium ions. In other words, lithium or sodium ions can be reversibly inserted or detached.

The positive electrode active material may be:
a metal oxide such as vanadium oxide VOₓ (2≤x≤2.5), LiV₃O₈, Li_{y}Ni₁₋ₓCoₓO₂ (0≤x≤1; 0≤y≤1), manganese spinel Li_{y}Mn₁₋ₓMₓO₂ (M=Cr, Al, V, Ni, 0≤x≤0.5; 0≤y≤2), V₂O₅, lithium oxides such as, for example, LiCoO₂, LiNiO₂, LiMn₂O₄, LiNi_{1/3}Mn_{1/3}CO_{1/3}O₂ (NMC), LiNi_{0.8}CO_{0.15}Al_{0.05}O₂ (NCA), and LiNi_{0.5}Mn_{0.5}O₂,
a phosphosilicate or metal phosphate, for example Li₃V₂ (PO₄)₃ or LiMPO₄, where M represents a metal cation selected from the group Fe, Mn, Co, Ni, Ti, and a combination thereof, or
a metal sulfate, for example iron sulfate Fe₂(SO₄)₃.

The active material of the positive electrode may represent from 50 to 90% by mass approximately, and preferably from 55 to 80% by mass approximately, relative to the total mass of the positive electrode.

### Agent Generating Electron Conductivity

The agent generating electron conductivity may be chosen from carbon blacks, acetylene blacks, carbon fibers and nanofibres, carbon nanotubes, graphene, graphite, metal particles and fibers of at least one conductive metal such as aluminum, platinum, iron, cobalt and nickel, and a mixture thereof.

The agent generating electron conductivity is preferably carbon black.

The agent generating electron conductivity can represent from 0.1 to 10% by mass approximately, and preferably from 0.5 to 5% by mass approximately, relative to the total mass of the positive electrode.

### Polymer Composition

The polymer composition is a polymer composition as defined in the first object of the invention.

The polymer composition may represent approximately from 10% to 49.5% by mass, and preferably approximately from 20 to 40% by mass, relative to the total mass of the positive electrode.

The positive electrode preferably does not comprise lithium or sodium molecular salts.

The positive electrode is preferably in the form of a film whose thickness is generally of the order of 20 to a hundred micrometers.

### Rechargeable Lithium or Sodium Battery

The fifth object of the invention is a rechargeable lithium or sodium battery, characterized in that it comprises:
a negative electrode comprising lithium metal, sodium metal, a lithium metal alloy or a sodium metal alloy,
a positive electrode, possibly supported by a current collector, and
a polymer electrolyte positioned between the positive and negative electrodes,

characterized in that the polymer electrolyte is as defined in the third object of the invention and/or the positive electrode is as defined in the fourth object of the invention.

### The Negative Electrode

The negative electrode is preferably in the form of a film whose thickness is generally of the order of 1 to a hundred micrometers.

The negative electrode may consist of lithium metal, sodium metal, one of the alloys of lithium such as an alloy of lithium with sodium, silicon, tin, aluminum, magnesium, silver, zinc or germanium, or one of the alloys of sodium such as an alloy of sodium with lithium, silicon, tin, magnesium, silver, zinc or germanium, silver, zinc or germanium.

The negative electrode preferably consists of lithium metal or one of its alloys.

### The Positive Electrode

The positive electrode may be a positive electrode according to the fourth object of the invention, or the positive electrode may comprise a positive electrode active material, a polymeric binder, optionally a plasticizer, and optionally an agent generating electron conductivity.

The positive electrode active material and the agent generating electron conductivity are as defined in the fourth object of the invention.

### Plasticizer

The plasticizer (or non-aqueous solvent) can be chosen from:
linear and cyclic carbonates such as propylene carbonate (PC), ethylene carbonate (EC), dimethyl carbonate (DMC), diethyl carbonate (DEC), or methyl isopropyl carbonate (MiPC);

fluorinated carbonates such as fluoroethylene carbonate;
nitriles such as succinonitrile;

lactones such as γ-butyrolactone;
liquid linear or cyclic polyethers such as dimethyl ether, polyethylene glycol dimethyl ether (or PEGDME) such as tetraethylene glycol dimethyl ether (TEGDME), or dioxolane;
fluorinated polyethers;
sulfur solvents such as sulfolane or dimethyl sulfoxide;
phosphates such as triethylphosphate or fluorophosphates;
esters such as ethyl acetate or ethyl butyrate (EB); and
mixtures thereof.

Among such solvents or plasticizers, linear and cyclic carbonates are particularly preferred.

The plasticizer of the positive electrode may represent approximately from 5 to 35% by mass, and preferably approximately from 10 to 25% by mass, relative to the total mass of the positive electrode.

### Polymer Binder

The polymer binder may be chosen from ethylene homopolymers and copolymers, homopolymers and copolymers of propylene; homopolymers and copolymers of ethylene oxide (e.g. PEO, copolymer of PEO), methylene oxide, propylene oxide, epichlorohydrin, allyl glycidyl ether, and mixtures thereof; halogenated polymers such as homopolymers and copolymers of vinyl chloride, vinylidene fluoride (PVdF), vinylidene chloride, ethylene tetrafluoride or chlorotrifluoroethylene, or mixtures thereof; electronically non-conductive anionic polymers such as poly(styrene sulfonate), poly(acrylic acid), poly(glutamate), alginate, pectin, gelatin or mixtures thereof; cationic polymers such as polyethyleneimine (PEI), polyaniline in the form of emeraldine salt(ES), quaternized poly(N-vinylimidazole), poly(acrylamide-diallyldimethyl ammonium chloride) (AMAC) or mixtures thereof; polyacrylates; elastomers such as homopolymers or copolymers of ethylene, propylene, styrene, butadiene, or chloroprene; cationic unipolar conducting polymers; and a mixture thereof.

The cationic unipolar conducting polymers can be as defined in the first object of the invention.

The polymer binder may represent approximately from 5 to 35% by mass, and preferably approximately from 10 to 25% by mass, relative to the total mass of the positive electrode.

According to a preferred embodiment of the invention, the active material of the positive electrode is coated with a layer of carbon. The presence of the carbon layer makes it possible to improve the interface: active material-polymer binder.

The carbon coating the active material preferably represents from 0.1 to 5% by mass approximately, relative to the mass of active material.

The carbon layer is preferably in the form of a layer with a thickness varying from 1 to 4 nm approximately.

The positive electrode may further comprise a lithium or sodium salt, particularly when the polymer binder is other than a cationic unipolar conducting polymer.

According to a particularly preferred embodiment of the invention, the positive electrode is a positive electrode conforming to the fourth object of the invention.

### The Current Collector

The rechargeable battery may further comprise a current collector connected to the positive electrode.

The current collector generally consists of a sheet of metal.

The current collector is preferably a current collector made of stainless steel or aluminum, optionally covered with a carbon-based layer (anti-corrosion layer).

### Polymer Electrolyte

The polymer electrolyte may be a polymer electrolyte conforming to the third object of the invention or the polymer electrolyte may comprise a cationic unipolar conducting polymer; or the combination of at least one lithium salt and at least one polymeric material selected from polyethylene oxide (PEO)-based polymeric materials, polycarbonates, and polydiesters.

The polymer material based on poly(ethylene oxide) (PEO) can be chosen from a polystyrene-poly(ethylene oxide) (PS-b-PEO) block copolymer, a polystyrene-poly(ethylene oxide)-polystyrene (PS-b-PEO-b-PS) block copolymer, a random poly(ethylene oxide-co-propylene oxide) copolymer (i.e. PEO-ran-PPO), a random poly(ethylene oxide-co-butylene oxide) copolymer (i.e. PEO-ran-PBO), a poly(ethylene oxide), and a mixture thereof.

The lithium salt used in combination with the polymer material based on poly(ethylene oxide) can be chosen from lithium fluorate (LiFO₃), lithium bis(trifluoromethanesulfonyl) imidide (LiTFSI), lithium hexafluorophosphate (LiPF₆), lithium fluoroborate (LiBF₄), lithium metaborate (LiBO₂), lithium perchlorate (LiClO₄), lithium nitrate (LiNO₃), lithium bis(fluorosulfonyl) imidide (LiFSI), lithium bis(pentafluoroethyl) imidide (LiBETI), LiAsF₆, LiCF₃SO₃, LiSbF₆, LiSbCl₆, Li₂TiCl₆, Li₂SeCl₆, Li₂B₁₀Cl₁₀, Li₂B₁₂CI₁₂, lithium bis(oxalato) borate (LiBOB), and a mixture thereof.

The lithium salt preferably represents from 5 to 30% by mass, and even more preferably from 10 to 25% by mass, relative to the total mass of the polymer electrolyte.

Said polymer material based on poly(ethylene oxide) (PEO) can be combined with a reinforcing agent. This thus makes it possible to modulate the mechanical properties of the polymer material.

Said reinforcing agent is preferably chosen from cellulose nanofibrils, ceramic nanoparticles such as titanium oxide, aluminum oxide or silicon oxide nanoparticles, and fluorinated polymers and copolymers such as polyvinylidene fluoride (PVdF) or the copolymer of vinylidene fluoride-hexafluoropropylene (PVdF-co-HFP).

The cationic unipolar conducting polymer can be as defined in the first object of the invention.

According to a particularly preferred embodiment of the invention, the polymer electrolyte is a polymer electrolyte conforming to the third object of the invention.

The present invention is illustrated by the following embodiments, to which it is not however limited.

### Examples

The raw materials used in the examples are listed below:
carbon black, Sumitomo Corp, reference “ECP-600JD”,
Lithium Manganese Iron Phosphate (LMFP), Huayi, grade 2,
PVDF, marketed as “5130” by Solvay, molar mass Mw=900,000 g/mol,
PVdF-HFP, marketed as “Kynarflex 2751” by Arkema,
propylene carbonate (PC), Aldrich, anhydrous, purity 99.7%,
triethyl phosphate (TEP), TCI, purity>99.0%,
PMTFSI: poly((trifluoromethane) sulfonimidide lithium methacrylate), Specific Polymers, molar mass Mn=238 330 g/mol,
PSTFSI: poly(styrene tri (fluoromethane) sulfonimidide), molar mass Mn=84,720 g/mol,
PMMA: poly(methyl methacrylate), Sigma-Aldrich, Mw ~ 996,000 g/mol,
Acetonitrile, Sigma-Aldrich, anhydrous, purity 99.8%,
lithium metal foil, Ganfeng extruded then laminated to 72 μm,
lithium metal electrode, Ganfeng extruded then laminated to 72 μm, 72 μm-thick lithium metal anode, Ganfeng extruded then laminated to 72 μm,
“EnSafe 65” collector, Armor.

Unless otherwise indicated, all the materials have been used as received from the manufacturers.

### Example 1: Preparation of a Polymer Electrolyte EP1* not Conforming To the Invention and Polymer Electrolytes EP2, EP3, EP4 and EP5 Conforming To the Invention

A plurality of polymer electrolytes comprising PVdF as an ionically non-conductive fluoropolymer, PMTFSI as a cationic unipolar conducting polymer, and propylene carbonate as a plasticizer were prepared as detailed below.

The components (ionically non-conductive fluoropolymer, cationic unipolar conducting polymer, and plasticizer) are mixed with acetonitrile (ACN) under magnetic stirring (300 rpm) at 100° C. in a beaker. For 1 g of a mixture of ionically non-conductive fluoropolymer and cationic unipolar conductive polymer, 1 g plasticizer and 5 g acetonitrile are used. After mixing, the resulting mixture is coated at 8 mm/s at room temperature onto a silicone-coated polyethylene terephthalate (PET) support to form a film, which is then dried in a fume hood for a few minutes to evaporate residual acetonitrile.

Table 1 below shows the mass percentages of the various constituents present in the electrolytes prepared according to the protocol described above, together with their thicknesses:

TABLE 1

| | | | | Film thickness |
|---|---|---|---|---|
| Polymer | PMTFSI | PVdF | PC | obtained |
| electrolyte | (% by mass) | (% by mass) | (% by mass) | (μm) |
| EP1* | 50 | 0 | 50 | 90 |
| EP2 | 30 | 20 | 50 | 21 |
| EP3 | 25 | 25 | 50 | 34 |
| EP4 | 20 | 30 | 50 | 20 |
| EP5 | 15 | 35 | 50 | 19 |

*not part of the invention

For each of the polymer electrolytes, a lithium electrolyte lithium (LEL) cell is then manufactured by successive laminations at 75° C. under dry air of a lithium foil, a polymer electrolyte film as prepared above, and another lithium foil.

For the polymer electrolyte not conforming to the invention EP1*, lamination is carried out at a pressure of 2 bar. For the other polymer electrolytes, EP2 to EP5, lamination is carried out at a pressure of 5 bar.

The cells LEL1*, LEL2, LEL3, LEL4, and LEL5 containing polymer electrolytes EP1*, EP2, EP3, EP4, and EP5 respectively are placed in 2-bar compression systems.

The ionic conductivity of polymer electrolytes EP1*, EP2, EP3, EP4, and EP5 is measured by impedance spectroscopy using a device sold under the trade name IM6EX by the Zahner company. Measurements are performed with the cells LEL1*, LEL2, LEL3, LEL4, and LEL5 as prepared above, in potentiostatic mode between 100 mHz and 1 MHz for an amplitude of 10 mV at 20° C. and 40° C.

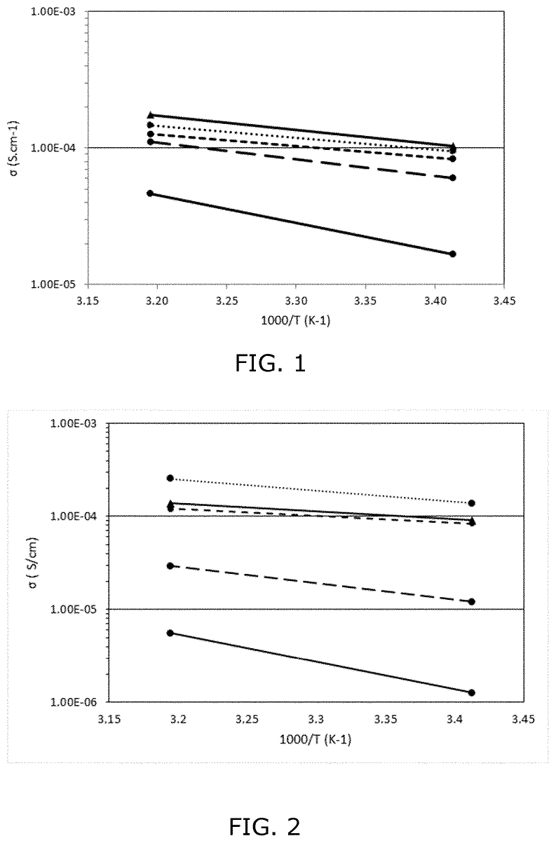

FIG. 1 shows the change in ionic conductivity in S.cm⁻¹ as a function of temperature (measured as the ratio 1000/temperature, in Kelvin-1) for the polymer electrolyte EP1* (curve with solid circles connected by a solid line), EP2 (curve with solid circles connected by a broad dotted line), EP3 (curve with solid circles connected by a normal dotted line), EP4 (curve with solid circles connected by a short dotted line), and EP5 (curve with solid triangles connected by a solid line). The higher the PVdF content of a polymer electrolyte, the greater its ionic conductivity. The introduction of PVdF, as an ionically non-conductive fluoropolymer, helps to increase the ionic conductivity of polymer electrolytes based on at least one cationic unipolar-conducting polymer such as PMTFSI plasticized with at least one plasticizer such as propylene carbonate.

### Example 2: Preparation of a Polymer Electrolyte EP6* not Conforming To the Invention and Polymer Electrolytes EP7, EP8, EP9 and EP10 Conforming to the Invention

A plurality of polymer electrolytes comprising PVdF as an ionically non-conductive fluoropolymer, PSTFSI as a cationic unipolar conducting polymer, and propylene carbonate as a plasticizer were prepared as detailed below.

The components (ionically non-conductive fluoropolymer, cationic unipolar conducting polymer, and plasticizer) are mixed with acetonitrile (ACN) under magnetic stirring (300 rpm) at 100° C. in a beaker. For 1 g of a mixture of ionically non-conductive fluoropolymer and cationic unipolar conductive polymer, 1 g plasticizer and 5 g acetonitrile are used. After mixing, the resulting mixture is coated at 8 mm/s at room temperature onto a silicone-coated polyethylene terephthalate (PET) support to form a film, which is then dried in a fume hood for a few minutes to evaporate residual acetonitrile.

Table 2 below shows the mass percentages of the various constituents present in the electrolytes prepared according to the protocol described above, together with their thicknesses:

TABLE 2

| | | | | Film thickness |
|---|---|---|---|---|
| Polymer | PSTFSI | PVdF | TEP | obtained |
| electrolyte | (% by mass) | (% by mass) | (% by mass) | (μm) |
| EP6* | 50 | 0 | 50 | 64 |
| EP7 | 35 | 15 | 50 | 39 |
| EP8 | 25 | 25 | 50 | 18 |
| EP9 | 15 | 35 | 50 | 32 |
| EP10 | 10 | 40 | 50 | 26 |

*not part of the invention

For each of the polymer electrolytes, a lithium electrolyte lithium (LEL) cell is then manufactured by successive laminations at 75° C. under dry air of a lithium foil, a polymer electrolyte film as prepared above, and another lithium foil.

For the polymer electrolyte not conforming to the invention EP6*, lamination is carried out at a pressure of 2 bar. In addition, two layers of polymer electrolyte EP6* are used to prevent short-circuiting. For the other polymer electrolytes conforming to the invention, EP7 to EP10, laminations are carried out at a pressure of 5 bar.

Cells LEL6*, LEL7, LEL8, LEL9, and LEL10 containing polymer electrolytes EP6*, EP7, EP8, EP9, and EP10 respectively are placed in 2-bar compression systems. The ionic conductivity of polymer electrolytes EP6*, EP7, EP8, EP9, and EP10 is measured as described in Example 1.

FIG. 2 shows the change in ionic conductivity in S.cm⁻¹ as a function of temperature (measured as the ratio 1000/temperature, in Kelvin-1) for the polymer electrolyte EP6* (curve with solid circles connected by a solid line), EP7 (curve with solid circles connected by a broad dotted line), EP8 (curve with solid circles connected by a normal dotted line), EP9 (curve with solid circles connected by a short dotted line), and EP10 (curve with solid triangles connected by a solid line). The introduction of PVdF, as an ionically non-conductive fluoropolymer, helps to increase the ionic conductivity of polymer electrolytes based on at least one cationic unipolar-conducting polymer such as PSTFSI plasticized with at least one plasticizer such as propylene carbonate. Ionic conductivity reaches a maximum at a PVdF content of 35% by mass, relative to the total mass of the polymer electrolyte.

### Example 3: Preparation of a Polymer Electrolyte EP11* not Conforming to the Invention and Polymer Electrolytes EP12 and EP13 Conforming to the Invention

A plurality of polymer electrolytes comprising PVdF as an ionically non-conductive fluoropolymer, PMTFSI as a cationic unipolar conducting polymer, and triethyl phosphate (TEP) as a plasticizer were prepared as detailed below.

The components (ionically non-conductive fluoropolymer, cationic unipolar conducting polymer, and plasticizer) are mixed with acetonitrile (ACN) under magnetic stirring (300 rpm) at 100° C. in a beaker. For 1 g of a mixture of ionically non-conductive fluoropolymer and cationic unipolar conductive polymer, 1 g plasticizer and 5 g acetonitrile are used. After mixing, the resulting mixture is coated at 8 mm/s at room temperature onto a silicone-coated polyethylene terephthalate (PET) support to form a film, which is then dried in a fume hood for a few minutes to evaporate residual acetonitrile.

Table 3 below shows the mass percentages of the various constituents present in the electrolytes prepared according to the protocol described above, together with their thicknesses:

TABLE 3

| | | | | Film thickness |
|---|---|---|---|---|
| Polymer | PMTFSI | PVdF | TEP | obtained |
| electrolyte | (% by mass) | (% by mass) | (% by mass) | (μm) |
| EP11* | 50 | 0 | 50 | 52 |
| EP12 | 35 | 15 | 50 | 23 |
| EP13 | 25 | 25 | 50 | 22 |

*not part of the invention

For each of the polymer electrolytes, a lithium electrolyte lithium (LEL) cell is then manufactured by successive laminations at 75° C. under dry air of a lithium foil, a polymer electrolyte film as prepared above, and another lithium foil.

For the polymer electrolyte not conforming to the invention EP11*, the laminations are made at a pressure of 2 bar and a lithium electrode is used instead of two lithium foils. For the other polymer electrolytes conforming to the invention, EP12 to EP13, the laminations are carried out at a pressure of 5 bar.

Cells LEL11*, LEL12, and LEL13 containing polymer electrolytes EP11*, EP12, and EP13 respectively are placed in 2-bar compression systems.

The ionic conductivity of polymer electrolytes EP11*, EP12, and EP13 is measured as described in Example 1.

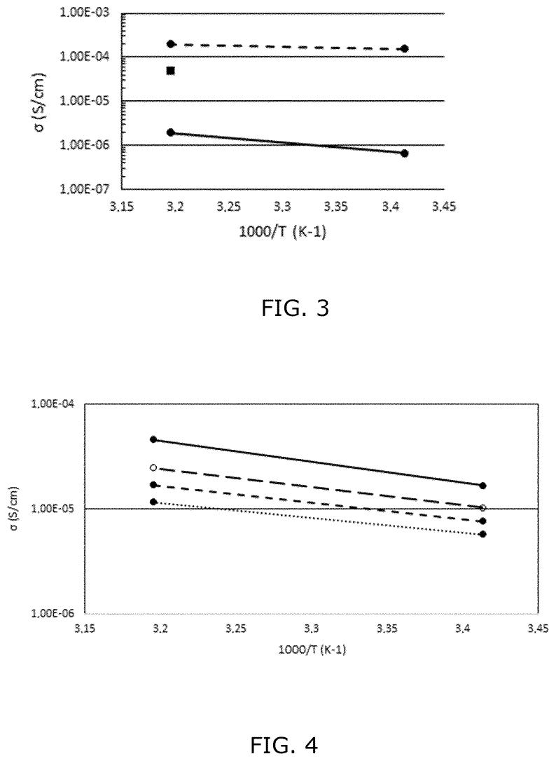

FIG. 3 shows the change in ionic conductivity in S.cm⁻¹ as a function of temperature (measured as the ratio 1000/temperature, in Kelvin-1) for polymer electrolyte EP11* (curve with solid circles connected by a solid line), EP12 (beginning of curve with a solid square), and EP13 (curve with solid circles connected by a dotted line). The higher the PVdF content of a polymer electrolyte, the greater its ionic conductivity. The introduction of PVdF, as an ionically non-conductive polymer, helps to increase the ionic conductivity of polymer electrolytes based on at least one cationic unipolar-conducting polymer such as PMTFSI plasticized with at least one plasticizer such as triethyl phosphate.

### Comparative Example 4: Preparation of Polymer Electrolytes EP14*, EP15* and EP16* not Conforming to the Invention

A plurality of polymer electrolytes comprising PMMA instead of PVdF as an ionically non-conductive non-fluorinated polymer, PMTFSI as a cationic unipolar conducting polymer, and propylene carbonate as a plasticizer were prepared as detailed below.

The components (ionically non-conductive non-fluorinated polymer, cationic unipolar conducting polymer, and plasticizer) are mixed with acetonitrile (ACN) under magnetic stirring (300 rpm) at 100° C. in a beaker. For 1 g of a mixture of ionically non-conductive non-fluorinated polymer PMMA and cationic unipolar conductive polymer, 1 g plasticizer and 5 g acetonitrile are used. After mixing, the resulting mixture is coated at 8 mm/s at room temperature onto a silicone-coated polyethylene terephthalate (PET) support to form a film, which is then dried in a fume hood for a few minutes to evaporate residual acetonitrile.

Table 4 below shows the mass percentages of the various constituents present in the electrolytes prepared according to the protocol described above, together with their thicknesses:

TABLE 4

| | | | | Film thickness |
|---|---|---|---|---|
| Polymer | PMTFSI | PMMA | PC | obtained |
| electrolyte | (% by mass) | (% by mass) | (% by mass) | (μm) |
| EP1* | 50 | 0 | 50 | 90 |
| EP14* | 35 | 15 | 50 | 30 |
| EP15* | 25 | 25 | 50 | 23 |
| EP16* | 15 | 35 | 50 | 26 |

*not part of the invention

For each of the polymer electrolytes, a lithium electrolyte lithium (LEL) cell is then manufactured by successive laminations at 75° C. under dry air of a lithium foil, a polymer electrolyte film as prepared above, and another lithium foil.

For the polymer electrolyte not conforming to the invention EP1*, lamination is carried out at a pressure of 2 bar. For the other polymer electrolytes, not conforming to the invention, EP14* to EP16*, lamination is carried out at a pressure of 5 bar.

Cells LEL1*, LEL14*, LEL15* and LEL16* containing polymer electrolytes EP1*, EP14*, EP15* and EP16* respectively are placed in 2-bar compression systems.

The ionic conductivity of polymer electrolytes EP1*, EP14*, EP15* and EP16* is measured as in Example 1.

FIG. 4 shows the change in ionic conductivity in S.cm⁻¹ as a function of temperature (measured as the ratio 1000/temperature, in Kelvin-1) for the polymer electrolyte EP1* (curve with solid circles connected by a solid line), EP14* (curve with solid circles connected by a broad dotted line), EP15* (curve with solid circles connected by a normal dotted line), and EP16* (curve with solid circles connected by a short dotted line). Unlike PVdF, the use of PMMA reduces the ionic conductivity of the polymer electrolyte.

### Example 5: Preparation of Cathodes C1* not Conforming to the Invention and C2 Conforming to the Invention

### Preparation of Cathodes C1* and C2

A first cathode (positive electrode) C1* not conforming to the invention (i.e. without PVdF as ionically non-conductive fluoropolymer) in the form of a film was prepared as follows: 1.32 g propylene carbonate (PC), 1.32 g PMTFSI, and 12 g ACN are mixed in a beaker under magnetic stirring at 300 rpm and 100° C. Then, 4.2 g of lithium manganese iron phosphate (LMFP), and 0.17 g of carbon black (KB) are added when a homogeneous result is obtained. The resulting mixture is then ground using a ball mill for 8 min at 30 rpm. The resulting mixture is coated at room temperature at 30 mm/s onto a collector known as “EnSafe 65” from Armor to form a cathode, which is calendered at 95° C. to reduce porosity. A thickness of 34 μm is obtained.

A second cathode C2 conforming to the invention (i.e. with PVdF as ionically non-conductive fluoropolymer) in the form of a film was prepared as follows: 1.32 g propylene carbonate (PC), 0.79 g PMTFSI, 0.53 g PVdF, and 18 g ACN are mixed in a beaker under magnetic stirring at 300 rpm and 100° C. Then, 4.2 g of lithium manganese iron phosphate (LMFP), and 0.17 g of carbon black (KB) are added when a homogeneous result is obtained. The resulting mixture is then ground using a ball mill for 8 min at 30 rpm. The resulting mixture is coated at room temperature at 30 mm/s onto a collector known as “EnSafe 65” from Armor to form a cathode, which is calendered at 95° C. to reduce porosity. A thickness of 40 μm is obtained.

Table 5 below shows the mass percentages of the various constituents present in the cathodes prepared according to the protocol described above:

TABLE 5

| Constituents | C1* | C2 |
|---|---|---|
| LMFP | 60 | 60 |
| (% by mass) | | |
| KB | 2.4 | 2.4 |
| (% by mass) | | |
| PMTFSI | 18.8 | 11.3 |
| (% by mass) | | |
| PVdF | 0 | 7.5 |
| (% by mass) | | |
| PC | 18.8 | 18.8 |
| (% by mass) | | |

*not part of the invention

### Preparation of a Polymer Electrolyte EP17 Conforming to the Invention

An EP17 polymer electrolyte conforming to the invention comprising PVdF as ionically non-conductive fluoropolymer, PMTFSI as cationic unipolar conductive polymer, and propylene carbonate as plasticizer was prepared as follows: The components (ionically non-conductive fluoropolymer, cationic unipolar conducting polymer, and plasticizer) are mixed with acetonitrile (ACN) under magnetic stirring (300 rpm) at 100° C. in a beaker. For 1 g of a mixture of ionically non-conductive fluoropolymer and cationic unipolar conductive polymer, 1 g plasticizer and 5 g acetonitrile are used. After mixing, the resulting mixture is first coated at 8 mm/s at room temperature onto the first side of a 16 μm-thick porous polypropylene separator to form a film, which is then dried in a fume hood for a few minutes to evaporate residual acetonitrile. The second side of the porous separator is then coated with the resulting mixture under the same conditions as for the first coating.

Table 6 below shows the mass percentages of the various constituents present in the polymer electrolytes EP17 prepared according to the protocol described above, together with their total thicknesses:

TABLE 6

| | | | | Film thickness |
|---|---|---|---|---|
| Polymer | PMTFSI | PVdF | PC | obtained |
| electrolyte | (% by mass) | (% by mass) | (% by mass) | (μm) |
| EP17 | 25 | 25 | 50 | 38 |

### Performance of Cathodes C1* and C2

For both of the cathodes C1* and C2, a 5 cm² cathode electrolyte cathode (CEC) cell is assembled with EP17 polymer electrolyte. Cells CEC1 and CEC2 with cathodes C1* and C2 respectively are assembled by successive lamination at 75° C. and 5 bars in dry air. These cells are placed in 2-bar compression systems.

Impedance spectroscopy measurements are carried out on each of these two cells. The ionic conductivity of electrolytes is measured by impedance spectroscopy. Measurements are performed in potentiostatic mode between 100 mHz and 1 MHz at an amplitude of 10 mV at 40° C.

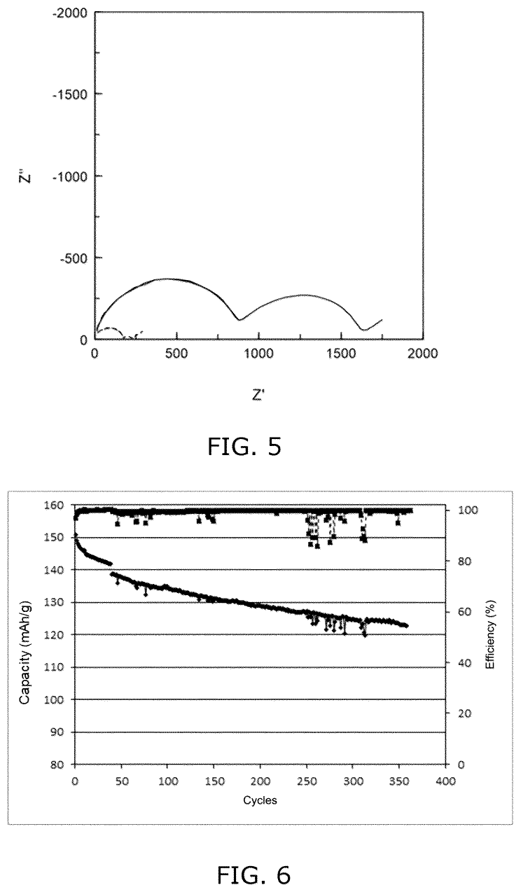

FIG. 5 shows the opposite of the imaginary part Z″ in ohms, as a function of the real part Z′ in ohms for cathode C1* (curve with dotted line), and for cathode C2 (curve with solid line). In FIG. 5, the first semicircle obtained at high frequency (HF) is attributed to the polymer electrolyte+catholyte contribution, and the second semicircle to the cathode/collector interfaces. The impedance of the polymer electrolyte+catholyte contribution at high frequency is 490.9% higher for cell CEC1 using a PVDF-free C1* cathode. As the polymer electrolyte EP17 is the same for both CEC1 and CEC2 cells, it can be concluded that the use of PVDF in a cathode based on LMFP and PMTFSI plasticized with PC contributes to improving the ionic conductivity of the catholyte.

Table 7 below lists, for each cathode C1* and C2, the characteristic frequency of the high-frequency contribution (in KHz) and the impedance of the high-frequency contribution (in kΩ2.cm²).

TABLE 7

| | Characteristic frequency of | |
|---|---|---|
| | high-frequency contribution | HF contribution impedance |
| Cathode | (in kHz) | (in kΩ · cm²) |
| C1* | 53.3 | 4.32 |
| C2 | 131.4 | 0.88 |

*not part of the invention

### Example 6: Preparation of a Battery According to the Invention

A lithium electrolyte cathode cell (LEC1) is prepared by successive lamination at 75° C. and 5 bar:
a polymer electrolyte EP3′ conforming to the invention, identical to EP3 as prepared in Example 1 except for its thickness, which is 18 μm instead of 34 μm,
a 72 μm-thick lithium metal anode, and
a cathode C3 conforming to the invention, then placed in a 2-bar compression system.

The cell LEC1 has a theoretical mass capacity of 5 mAh/g.

The cathode C3 conforming to the invention in the form of a film was previously prepared as follows: 1.32 g propylene carbonate (PC), 1.06 g PMTFSI, 0.26 g PVdF, and 15 g ACN are mixed in a beaker under magnetic stirring at 300 rpm and 100° C. Then, 4.2 g of lithium manganese iron phosphate (LMFP), and 0.17 g of carbon black (KB) are added when a homogeneous result is obtained. The resulting mixture is then ground using a ball mill for 8 min at 30 rpm. The resulting mixture is coated at room temperature at 30 mm/s onto a collector known as “EnSafe 65” from Armor to form a cathode, which is calendered at 95° C. to reduce porosity. A thickness of 37 μm is obtained.

Table 8 below shows the mass percentages of the various constituents present in the cathode C3 prepared according to the protocol described above:

TABLE 8

| Constituents | C3 |
|---|---|
| LMFP | 60 |
| (% by mass) | |
| KB | 2.4 |
| (% by mass) | |
| PMTFSI | 15.04 |
| (% by mass) | |
| PVdF | 3.76 |
| (% by mass) | |
| PC | 18.8 |
| (% by mass) | |

Cycling at 40° C. was carried out (a 3 h pause is marked when the cell is placed in the oven) according to the following protocol:
a 10 hr activation is first performed by applying a voltage of 3.3V vs Li/Li⁺;
LEC1 performs an initial C/10 charge with a cut-off voltage of 4.2V vs Li/Li⁺;
the voltage of 4.2V vs Li/Li⁺ is maintained for 1 h30, followed by a D/10 discharge with a cut-off voltage of 2.5V vs Li/Li⁺;
following this first cycle, the battery cycles at C/10-D/5. The cut-off voltages for charging and discharging remain 4.2V vs Li/Li⁺ and 2.5V vs Li/Li⁺ respectively. Each charge is punctuated by a voltage of 4.2V vs Li/Li⁺ imposed for 1 hr30; after 40 cycles, the applied cycle becomes C/4-D/2.

After 358 cycles, the cell has a discharge capacity of 123 mAh/g and an efficiency equal to 99.8%.

FIG. 6 shows the capacity of the cell LEC1 (in mAh/g) as a function of the number of cycles (curve with solid diamonds), and the efficiency of the cell LEC1 (in %) as a function of the number of cycles (curve with solid squares).

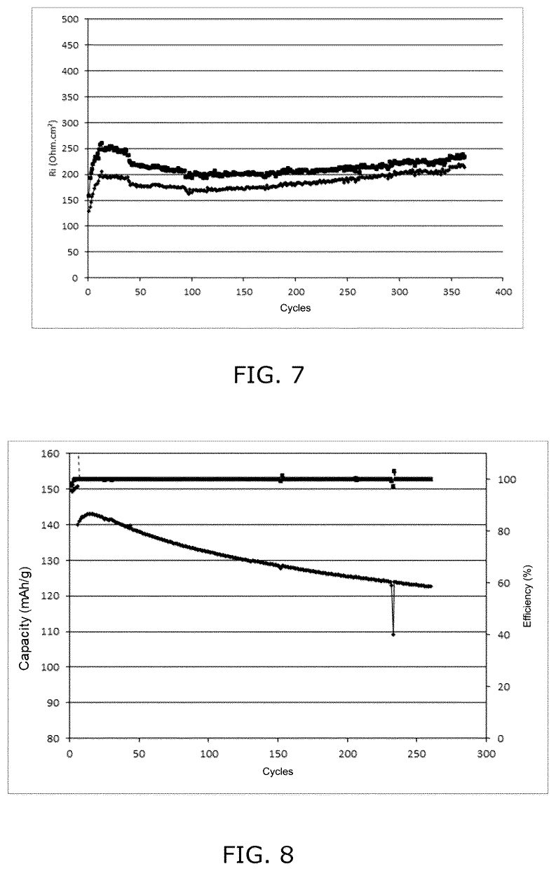

FIG. 7 shows the internal resistance Ri of the cell LEC1 (in Ohm.cm²) as a function of the number of cycles, in discharge (curve with solid diamonds) and in load (curve with solid squares).

### Example 7: Preparation of a Battery According to the Invention

A lithium electrolyte cathode cell (LEC2) is prepared by successive lamination at 75° C. and 5 bar:

the polymer electrolyte EP17 as prepared in Example 5 conforming to the invention,
a 72 μm-thick lithium metal anode, and
a cathode C3 as prepared in Example 6 conforming to the invention, then placed in a 2-bar compression system.

The cell LEC2 has a theoretical mass capacity of 6 mAh/g.

Table 9 below shows the mass percentages of the various constituents present in the cathode C3 prepared according to the protocol described above:

TABLE 9

| Constituents | C3 |
|---|---|
| LMFP | 60 |
| (% by mass) | |
| KB | 2.4 |
| (% by mass) | |
| PMTFSI | 15.04 |
| (% by mass) | |
| PVdF | 3.76 |
| (% by mass) | |
| PC | 18.8 |
| (% by mass) | |

A cycling protocol identical to that described in Example 6 has been carried out, with the difference that the applied cycle becomes C/4-D/2 at the end of the 7th cycle instead of the 40th cycle.

After 260 cycles, the cell has a discharge capacity of 123 mAh/g and an efficiency equal to 100%.

FIG. 8 shows the capacity of the cell LEC2 (in mAh/g) as a function of the number of cycles (curve with solid diamonds), and the efficiency of the cell LEC2 (in %) as a function of the number of cycles (curve with solid squares).

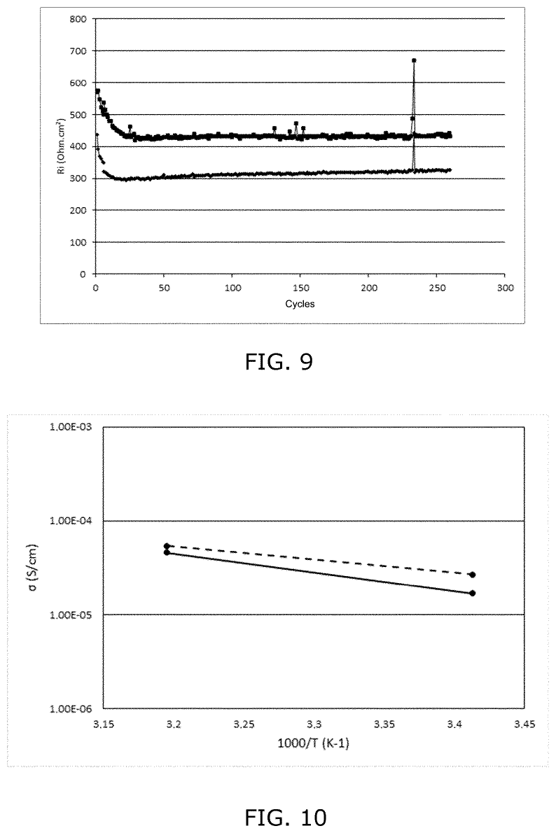

FIG. 9 shows the internal resistance Ri of the cell LEC2 (in Ohm.cm²) as a function of the number of cycles, in discharge (curve with solid diamonds) and in load (curve with solid squares).

### Example 8: Preparation of a Polymer Electrolyte EP18 Conforming to The Invention

A polymer electrolyte comprising PVdF-HFP as an ionically non-conductive fluoropolymer, PMTFSI as a cationic unipolar conducting polymer, and propylene carbonate as a plasticizer was prepared as detailed below.

The components (ionically non-conductive fluoropolymer, cationic unipolar conducting polymer, and plasticizer) are mixed with acetonitrile (ACN) under magnetic stirring (300 rpm) at 100° C. in a beaker. For 1 g of a mixture of ionically non-conductive fluoropolymer and cationic unipolar conductive polymer, 1 g plasticizer and 5 g acetonitrile are used. After mixing, the resulting mixture is coated at 8 mm/s at room temperature onto a silicone-coated polyethylene terephthalate (PET) support to form a film, which is then dried in a fume hood for a few minutes to evaporate residual acetonitrile.

Table 10 below shows the mass percentages of the various constituents present in the electrolyte prepared according to the protocol described above, together with its thicknesses:

TABLE 10

| | | | | Film thickness |
|---|---|---|---|---|
| Polymer | PMTFSI | PVdF-HFP | PC | obtained |
| electrolyte | (% by mass) | (% by mass) | (% by mass) | (μm) |
| EP18 | 25 | 25 | 50 | 33 |

The polymer electrolyte EP18 was compared with the polymer electrolyte EP1* not conforming to the invention prepared in Example 1 (i.e. free of ionically non-conductive fluoropolymer).

Two lithium electrolyte lithium (LEL) cells are then manufactured by successive lamination at 75° C. under dry air of a lithium foil, a polymer electrolyte film, and another lithium foil.

For the polymer electrolyte not conforming to the invention EP1*, lamination is carried out at a pressure of 2 bar. For the polymer electrolyte conforming to the invention EP18, lamination is carried out at a pressure of 5 bar.

Cells LEL1* and LEL18 containing polymer electrolytes EP1* and EP18 are placed in 2-bar compression systems.

The ionic conductivity of polymer electrolytes EP1* and EP18 is measured as described in Example 1.

FIG. 10 shows the change in ionic conductivity in S.cm⁻¹ as a function of temperature (measured as the ratio 1000/temperature, in Kelvin⁻¹) for polymer electrolyte EP1* (curve with solid circles connected by a solid line) and EP18 (curve with solid circles connected by a dotted line). The ionic conductivity of a polymer electrolyte is improved in the presence of PVdF-HFP as an ionically non-conductive fluoropolymer.

1-13. (canceled)

14. A polymer composition, comprising at least one cationic unipolar conducting polymer, at least one plasticizer, and at least one ionically non-conductive fluoropolymer, said cationic unipolar conducting polymer being a homopolymer or copolymer comprising at least one organic polymer chain, organic anionic functions forming covalent bonds with the organic polymer chain, and metal cations associated with the organic anionic functions.

15. The polymer composition according to claim 14, wherein the cationic unipolar conducting polymer is:
a homopolymer preparable from a) a monomer comprising at least one organic anionic function covalently grafted onto said monomer and at least one metal cation associated with the organic anionic function; or
a copolymer preparable from a) a monomer comprising at least one organic anionic function covalently grafted onto said monomer and at least one metal cation associated with the organic anionic function, and b) at least one monomer different from monomer a), selected from b1) monomers comprising at least one organic anionic function covalently grafted onto said monomer and at least one metal cation associated with the organic anionic function, and b2) organic monomers.

16. The polymer composition according to claim 14, wherein the metal cations associated with the organic anionic functions are chosen from Li⁺ and Na⁺ cations.

17. The polymer composition according to claim 14, wherein the organic anionic functions are bis sulfonyl imidides.

18. The polymer composition according to claim 14, wherein the cationic unipolar conducting polymer represents from 5% to 40% by weight, relative to the total weight of the polymer composition.

19. The polymer composition according to claim 14, wherein the ionically non-conductive fluoropolymer represents from 5% to 45% by weight, relative to the total weight of the polymer composition.

20. The polymer composition according to claim 14, wherein the ionically non-conductive fluoropolymer is selected from group consisting of: vinyl fluoride (VF) homopolymers and copolymers, vinylidene fluoride (VdF) homopolymers and copolymers, ethylene tetrafluoride (TFE) homopolymers and copolymers, chlorotrifluoroethylene (CTFE) homopolymers and copolymers, hexafluoropropylene (HFP) homopolymers and copolymers, and mixtures thereof.

21. The polymer composition according to claim 14, wherein the plasticizer is selected from the group consisting of: linear and cyclic carbonates; fluorinated carbonates; nitriles; lactones; liquid linear and cyclic polyethers; fluorinated polyethers; sulfur-containing solvents; phosphates; esters; and mixtures thereof.

22. The polymer composition according to claim 14, wherein the plasticizer represents from 25% to 90% by weight, relative to the total weight of the polymer composition.

23. A method for preparing a polymer electrolyte and/or a positive electrode of a rechargeable battery, comprising adding the polymer composition according to claim 14 to a polymer electrolyte composition and/or a positive electrode composition.

24. A polymer electrolyte for a rechargeable battery, comprising the polymer composition as defined in claim 14, or a porous separator impregnated with the polymer composition.

25. A positive electrode for a rechargeable battery comprising a positive electrode active material, a polymer composition, and optionally an electronic conductivity generating agent, wherein the polymer composition is as defined in claim 14.

26. A rechargeable lithium or sodium battery, comprising:
a negative electrode comprising lithium metal, sodium metal, a lithium metal alloy or a sodium metal alloy,
a positive electrode, possibly supported by a current collector, and
a polymer electrolyte positioned between the positive and negative electrodes, wherein the polymer electrolyte comprises the polymer composition as defined in claim 14 or a porous separator impregnated with the polymer composition; and/or
wherein the positive electrode comprises a positive electrode active material, the polymer composition, and optionally an electronic conductivity generating agent.
